(19) United States
(12) Patent Application Publication
(10) Pub. No.: US 2014/0201420 A1
(43) Pub. Date: Jul. 17, 2014

(54) TRANSMISSION INTERFACE SYSTEM WITH DETECTION FUNCTION AND METHOD

(71) Applicant: ASUSTeK COMPUTER INC., Taipei (TW)

(72) Inventors: Chang-Yu HSIEH, Taipei (TW); Pai-Ching HUANG, Taipei (TW); Li-Chien WU, Taipei (TW)

(73) Assignee: ASUSTeK COMPUTER INC., Teipei (TW)

(21) Appl. No.: 13/967,365

(22) Filed: Aug. 15, 2013

(30) Foreign Application Priority Data
Jan. 15, 2013 (CN) 201310013539.6

(51) Int. Cl. G06F 13/40

(52) U.S. Cl. CPC G06F 13/4022; G06F 13/4068
USPC 710/316; 710/305

(57) ABSTRACT

A transmission interface system includes a connector; a detecting unit, a control unit, a chipset and a resetting unit. The connector includes lots of transmission interfaces. The detecting unit detects the data type of the current transmitting data and outputs a detecting signal; the control unit receives the detecting signal and informs the resetting unit to output a resetting signal to the chipset. The chipset is reset after receiving the resetting signal, and then the control unit informs the chipset to output a data signal corresponding to the data type of the current transmitting data to the connector.

### CROSS-REFERENCE TO RELATED APPLICATION

This application claims the priority benefit of China application serial No. 201310013539.6 filed on Jan. 15, 2013. The entirety of the above-mentioned patent application is hereby incorporated by reference herein and made a part of specification.

### BACKGROUND OF THE INVENTION

1. Field of the Invention

The invention relates to transmission interface system a system and, more particularly, to a transmission interface system with detection function and detecting method.

2. Description of the Related Art

With the development of technology, electronic products gradually become light, small and thin to meet the requirements for portability.

However, electronic products usually need to have kinds of transmission interfaces due to the large number of peripheral devices connected to the electronic products; each transmission interface occupies a part of the housing of electronic products, which makes the design of thin and light electronic products more difficult.

### BRIEF SUMMARY OF THE INVENTION

A transmission interface system with detection function and detecting method are provided. They use a common transmission interface to transmit a plurality of different types of data signals. As a result, due to the integration of multiple transmission interfaces, the electronic products can be smaller and thinner.

A transmission interface system with detection function includes a connector, a detecting unit, a control unit, a chipset and a resetting unit. The connector includes lots of transmission interfaces. In structure, the detecting unit is electrically connected to the connector. The control unit is electrically connected to the detecting unit. The chipset is electrically connected to the connector and the control unit, and the resetting unit is electrically connected to the chipset and the control unit.

In operation, the detecting unit detects the data type of the current transmitting data and outputs a detecting signal, and the control unit receives the detecting signal.

In one embodiment, when an external transmission interface is connected to the connector, the detecting unit detects the voltage level of the external transmission interface to determine the type of the current transmitting data.

The control unit informs the resetting unit to output a resetting signal to the chipset according to the detecting signal, the chipset is reset after receiving the resetting signal, and the control unit informs the chipset to output a data signal corresponding to the data type of the current transmitting data to the connector.

In another embodiment, the detecting unit detects pins of the external transmission interface to determine the type of the current transmitting data. The transmission interface system further includes a switch unit; the switch unit includes an input port and a plurality of output ports, the switch unit switches among the output ports. The input port is electrically connected to the chipset, the first output port is electrically connected to the transmission interface supporting the first-type data; the second output port is electrically connected to the transmission interface supporting the second-type data. The control unit controls the switch unit to switch to the first output port or the second output port according to the detecting signal, and the chipset outputs the data signal corresponding to the data type of the current transmitting data to the connector.

A transmission interface system with detecting function includes the following steps: providing a connector, wherein the connector includes a first transmission interface supporting a first-type data and a second transmission interface supporting a second-type data; detecting the data type of the current transmitting data and outputting a detecting signal via a detecting unit; informing a resetting unit to output a resetting signal to a chipset via a control unit according to the detecting signal; and Informing the chipset to output a corresponding data signal to the connector via the control unit.

According to an embodiment, the step of detecting the data type of the current transmitting data includes: when an external transmission interface is connected to the connector, the detecting unit detects the voltage level of the external transmission interface to determine the type of the current transmitting data.

According to another embodiment, the step of detecting the data type of the current transmitting data includes: the detecting unit detects pins of the external transmission interface to determine the type of the current transmitting data.

According to a third embodiment, the step of informing the chipset to output a corresponding data signal to the connector via the control unit includes the step of providing a switch unit, the switch unit includes an input port and a plurality of output ports, the switch unit switches among the output ports. The input port is electrically connected to the chipset, the first output port is electrically connected to the first transmission interface supporting the first-type data, and the second output port is electrically connected to the second transmission interface supporting the second-type data. The control unit controls the switch unit to switch to the first output port or the second output port according to the detecting signal, and the chipset outputs the data signal corresponding to the data type of the current transmitting data to the connector, and the chipset may be a south bridge chip, which is not limited, herein.

Therefore, a transmission interface system with detection function in embodiments utilizes a common transmission interface to transmit two different types of data signals. As a result, due to the integration of multiple transmission interfaces, it only occupies a small part of the housing of the electronic products, and the electronic products can be smaller and thinner.

### BRIEF DESCRIPTION OF THE DRAWINGS

FIG. 1 is a schematic diagram showing a transmission interface system with detection function in an embodiment; and

FIG. 2 is a schematic diagram showing transmission interface system with detecting method in an embodiment

### DETAILED DESCRIPTION OF THE EMBODIMENTS

These and other features, aspects, and advantages of the present invention will become better understood with regard to the following description, appended claims, and accompanying drawings. Persons having ordinary skill in the art may make various modifications and changes without departing, from the scope and spirit of the invention.

A transmission interface system with detection function including a connector is provided. The connector is an integrated connector used for integrating kinds of transmission interfaces. For example, the connector includes a first transmission interface supporting a first-type data and a second transmission interface supporting a second-type data, and thus it is adapted to be coupled with kinds of male ends of external transmission interfaces.

Practically, the transmission interface system for supporting the first and the second type data may be the Universal Serial Bus (USB), Peripheral Component Interconnect Express (PCIE) or Serial Advanced Technology Attachment (SATA). For example, the USB may be USB 2.0 or USB 3.0, and the SATA may be SATA 3G or SATA 60, which is not limited herein.

Thus, even if the electronic components needs lots of transmission interface female ends for inserting different external transmission interfaces thereto, the transmission interface system with a detection function in the invention integrates multiple transmission interfaces into a connector. Furthermore, it only occupies a small part of the housing of the electronic products, which facilitates electronic products thinner and smaller.

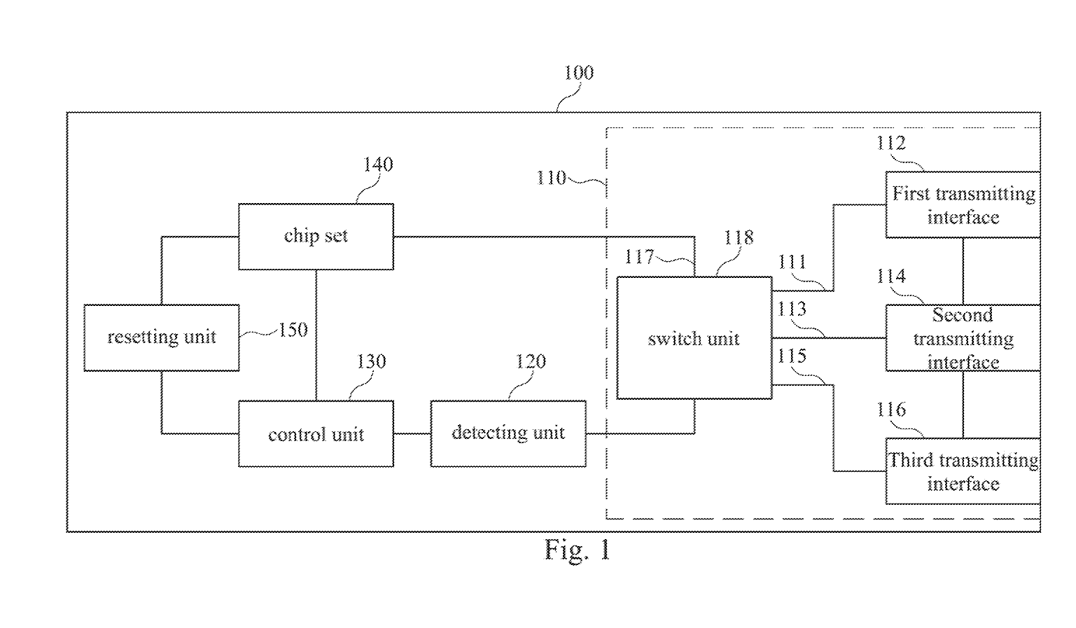

FIG. 1 is a schematic diagram showing a transmission interface system with a detection function in an embodiment. The transmission interface system with detection function 100 includes a connector 10, a detecting unit 120, a control unit 130, a chipset 140 and a resetting unit 150.

The connector may include a switch unit 118, a first transmission interface 112 supporting a first-type data, a second transmission interface 114 supporting a second-type data, and a third transmission interface 116 supporting a third-type data.

The detecting unit 120 is electrically connected to the connector 110, the control unit 130 is electrically connected to the detecting unit 120; the chipset 140 is electrically connected to the connector 110 and the control unit 130, and the resetting unit 150 is electrically connected to the chipset 140 and the control unit 130, the configuration of the components is not limited to that in FIG. 1.

The connector is adapted to be coupled with kinds of external transmission interfaces due to it includes the first transmission interface 112, 114, 116 supporting the first-type data, the second-type data and the third-type data. The detecting unit 120 outputs a detecting signal according to the current transmitting data. The control unit 130 receives the detecting signal and informs the resetting unit 150 to output a resetting signal to the chipset 140 according to the detecting signal.

After the chipset 140 resets according to the resetting signal, the control unit 130 informs the chipset 140 to output a data signal corresponding, to the current transmitting data to the connector 110. The chipset 140 may be a south bridge chip, which is not limited herein.

Accordingly, the connector 110 with the above circuit structure can detecting the type of the male end of an external transmission interface which is inserted into the connector 110, and then the chipset 140 can be controlled to output a proper signal to the male end of the external transmission interface. Therefore, the transmission interface system with detection function 100 can operate normally regardless the type of the male end of the external transmission interface.

In an embodiment, when the external transmission interface is connected to the connector 110, the detecting unit detects the voltage level of the male end of the external transmission interface to determine the type of the male end of the external transmission interface, therefore to obtain the type of the current transmitting data. For example, the operating voltage of the USB is 300 mV to −300 mV, and operating voltage of the SATA is 250 mV to −250 mV, the detecting unit 120 can determine the type of the male end of the external transmission interface according to the different voltage levels.

In another embodiment, the detecting unit 120 detects pins of the male end of the external transmission interface to determine the type of the end of the external transmission interface, therefore to obtain the type of the current transmitting data. For example, the size and the structure of different male ends of different external transmission interfaces may be different, in the embodiment, by detecting the pin of the male end of an external transmission interface; it can determine the type of the male end of an external transmission interface.

In a third embodiment, the switch unit 118 includes an input port 117, a first output port 111, a second output port 113 and a third output port 115. The switch unit 118 switches among the first output port 111, the second output port 113 and the third output port 115. The input port 117 is electrically connected to the chipset 140, the first output port 111 is electrically connected to the first transmission interface 112 supporting the first-type data, the second output port 113 is electrically connected to the second transmission interface 114 supporting the second-type data, the third output port 115 is electrically connected to the third transmission interface 116 supporting the third-type data. The control unit 130 controls the switch unit 118 to switch to the first output port 111, the second output port 113 or the third output port 115 according to the detecting signal, and the chipset 140 outputs the data signal corresponding to the data type of the current transmitting data to the connector 110.

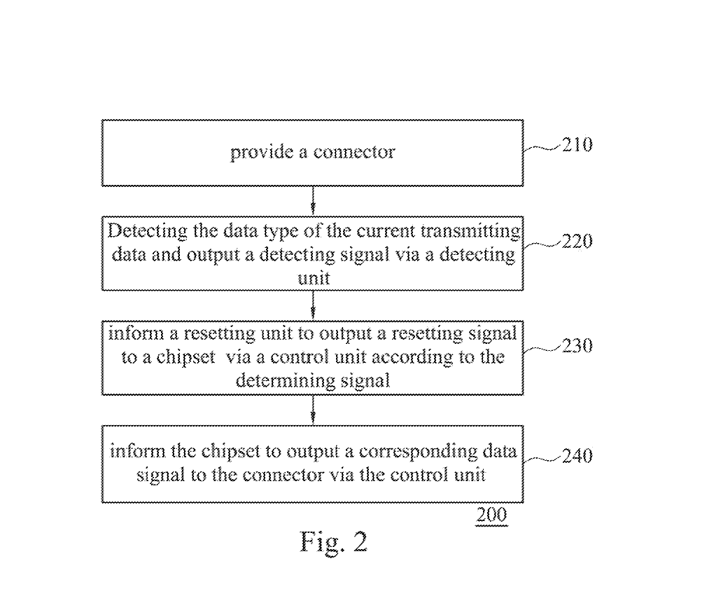

FIG. 2 is a schematic diagram showing a transmission interface system with detecting method in an embodiment, the transmission interface system with detecting method includes the following steps:

Step 210: a connector is provided, the connector includes first a transmission interface supporting a first-type data and a second transmission interface supporting a second-type data;

Step 220: detecting the data type of the current transmitting data and outputting a detecting signal via a detecting unit;

Step 230: informing a resetting unit to output a resetting signal to a chipset via a control unit according to the detecting signal;

Step 240: informing the chipset to output a corresponding data signal to the connector via the control unit.

Please refer to the FIG. 1 and FIG. 2. In the step 210, the connector 110 is provided; the connector 110 includes the first transmission interface 112 supporting the first-type data and the second transmission interface 114 supporting the second-type data. Then, the detecting unit 120 detects the type of the current transmitting data and outputs a detecting signal (step 220).

Please refer to the step 230, the control unit 130 informs the rescuing unit 150 to output a resetting signal to the chipset 140 according to the detecting signal, in step 240, the control unit 130 informs the chipset 140 to output a data signal corresponding to the type of the transmission interface to the connector 110.

Therefore, the transmission interface system with detecting method 200 can detect the type of the male end of an external transmission interface which is inserted in the connector 110, and the chipset 140 is controlled to output the proper signal to the male end of the external transmission interface. Therefore, the transmission interface system with detecting method 200 can operate normally regardless of the type of the external transmission interfaces male ends.

In an embodiment, the step of detecting the data type of the current transmitting data includes: the detecting unit detects the voltage level of the external transmission interface to determine the type of external transmission interface. For example, the detecting unit 120 detects the voltage level of the male end of the external transmission interface to determine the type of the external transmission interface and obtain the data type of the current transmitting data. The detailed operations have been mentioned in FIG. 1, which is omitted here.

In another embodiment, the step of detecting the data type of the current transmitting data includes: the detecting unit detects pins of the external transmission interface to determine the type of external transmission interface and obtain the data type of the current transmitting data. For example, the detecting unit 120 detects the pins of the male end of the external transmission interface to determine the type of male end of the external transmission interface. The detailed operations have been mentioned in FIG. 1, which is omitted here.

According to further another embodiment, the step of informing the chipset to output a corresponding data signal to the connector via the control unit includes: providing the switch unit 118, the switch unit 118 includes the input port 117, the first output port 111, the second output port 113 and the third output port 115. The switch unit 118 switches among the first output port 111, the second output port 113 and the third output port 115. The input port 117 is electrically connected to the chipset 140, the first output port 111 is electrically connected to the first transmission interface 112 supporting the first-type data, the second output port 113 is electrically connected to the second transmission interface 114 supporting the second-type data, the third output port 115 is electrically connected to the third transmission interface 116 supporting the third-type data. The control unit 130 controls the switch unit 118 to switch to the first output port 111, the second output port 113 or the third output port 115 according to the detecting signal, and the chipset 140 outputs the data signal corresponding to the data type of the current transmitting data to the connector 110. The detailed operating conditions have been mentioned in FIG. 1, which is omitted here.

The transmission interface system with detecting function as described above can be implemented by software, hardware and/or firmware. For example, if execution speed and accuracy is the primary consideration, hardware and/or firmware may be the first choice; while if the design flexibility is the primary consideration, software is better; or the software, hardware and firmware can be used simultaneously. The examples above are not used to limit the invention.

In the embodiments of the invention, it provides a transmission interface system with detection function and detecting method which uses a common transmission interface to transmit two different types of data signals. As a result, due to the integration of multiple transmission interfaces, it only occupies a small part of the housing of the electronic products; the electronic products can be smaller and thinner.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A transmission interface system with detection function, comprising:
a connector;
a detecting unit, electrically connected to the connector and used for determining the data type of the current transmitting data and outputting a detecting signal:
a control unit, electrically connected to the detecting unit and used for receiving the detecting signal;
a chipset, electrically connected to the connector and the detecting unit, and
a resetting unit, electrically connected to the chipset and the control unit;
wherein the control unit informs the resetting unit to output a resetting signal to the chipset according to the detecting signal, the chipset is reset after receiving the resetting signal, and then the control unit informs the chipset to output a data signal to the connector corresponding to the data type of the current transmitting data.

2. The transmission interface system according to claim 1, wherein when the external transmission interface is connected to the connector, the detecting unit detects the voltage level of the external transmission interface to determine the data type of the current transmitting data.

3. The transmission interface system according to claim 2, wherein the detecting unit further detects pins of the external transmission interface to determine the data type of the current transmitting data.

4. The transmission interface system according to claim 1, wherein the connector further includes a switch unit, the switch unit includes an input port and a plurality of output ports, the switch unit switches among the output ports, the input port is electrically connected to the chipset, and the control unit controls the switch unit to switch to the corresponding output port according to the detecting signal to make the chipset output the data signal corresponding to the data type of the current transmitting data to the connector.

5. The transmission interface system according to claim 1, wherein the transmission interface includes at least one of the Universal Serial Bus (USB), Peripheral Component Interconnect Express (PCIE), and Serial Advanced Technology Attachment (SATA).

6. A transmission interface system with detecting method, comprising:
providing a connector;
detecting the data type of the current transmitting data and outputting a detecting signal via a detecting unit;
informing a resetting unit to output a resetting signal to a chipset via a control unit according to the detecting signal; and
informing the chipset to output a corresponding data signal to the connector via the control unit.

7. The transmission interface system with detecting method according to claim 6, wherein the step of detecting the data type of the current transmitting data includes:
when the external transmission interface is connected to the connector, the detecting unit detects the voltage level of the external transmission interface to determine the data type of the current transmitting data.

8. The transmission interface system with detecting method according to claim 6, wherein the step of detecting the data type of the current transmitting data includes:
detecting pins of the external transmission interface via the detecting unit to determine the data type of the current transmitting data.

9. The transmission interface system with detecting method according to claim 6, wherein the step of informing the chipset to output a corresponding data signal to the connector via the control unit includes:
providing a switch unit, wherein the switch unit includes an input port and a plurality of output ports, and the switch switches among the output ports; and
controlling the switch unit to switch to the corresponding output port to make the chipset output the data signal corresponding to the data type of the current transmitting data to the connector.
